(19) United States
(12) Patent Application Publication
(10) Pub. No.: US 2015/0186476 A1
(43) Pub. Date: Jul. 2, 2015

(54) SEARCH METHOD AND INFORMATION PROCESSING DEVICE

(71) Applicant: FUJITSU LIMITED, Kawasaki-shi (JP)

(72) Inventors: Fumihito NISHINO, Koto (JP); Nobuyuki IGATA, Kawasaki (JP)

(73) Assignee: FUJITSU LIMITED, Kawasaki-shi (JP)

(21) Appl. No.: 14/536,963

(22) Filed: Nov. 10, 2014

(30) Foreign Application Priority Data
Dec. 27, 2013 (JP) 2013-272140

(51) Int. Cl. G06F 17/30; G06F 3/0484

(52) U.S. Cl. CPC G06F 17/30554; G06F 3/0484

(57) ABSTRACT

An acceptance unit accepts a focus and a standpoint from a user, and a page screen generation unit acquires a page screen definition on the basis of the standpoint. A gadget screen generation unit then uses a plurality of gadget definitions included in the page screen definition to generate a plurality of pieces of gadget screen data. A screen display unit thereafter displays a screen including the plurality of gadget screens. When a company corresponds to the focus and a vendor organization corresponds to the standpoint, for example, a search unit displays on the gadget screen a pie chart representing a sum of order volume by each orderer, a pie chart representing a sum of order volume by each orderer including affiliated companies, and an organization chart.

### CROSS-REFERENCE TO RELATED APPLICATION(S)

This application is based upon and claims the benefit of priority of the prior Japanese Patent Application No. 2013-272140, filed on Dec. 27, 2013, the entire contents of which are incorporated herein by reference.

### FIELD

The embodiments discussed herein are related to a search method and an information processing device.

### BACKGROUND

The use of Linked Data has been increasing recently as a method of publishing data on the Web. Linked Data is a scheme of using the Web as global data space. The existing Web is “the Web of documents mainly intended to be read by people”, whereas Linked Data is “the Web of data intended for machine processing”. To publish data on the Web, we first have to identify the items of interest in our domain. They are the things whose properties and relationships we want to describe in the data. In Web Architecture terminology, all items of interest are called resources. Resources are identified using Uniform Resource Identifiers (URIs). URI Dereferencing is the process of looking up a URI on the Web in order to get information about the referenced resource. Data-driven dynamic publishing approach uses Linked Data technology to automate the aggregation and publishing of interrelated resources.

Moreover, a screen on the Web is generated by using a gadget as well as by directly describing the content on the screen with use of an HTML or the like. The gadget here is a component which retrieves data from a database and displays the data after processing it. The gadget is used to make it possible to display data side by side on one screen, the data being acquired from a plurality of databases associated in Linked Data.

An information analysis or the like can thus be assisted by displaying the data associated in Linked Data side by side. Accordingly, there has been promoted the development of a platform for publishing data based on Linked Data.

Non-Patent Literature 1: Igata, Nishino, Kume, and Matsutsuka, “Information Integration and Utilization Technology Using Linked Data”, FUJITSU. 64, 5, p. 464-470 (09, 2013)

Non-Patent Literature 2: “Information Workbench”, Retrieved Dec. 4, 2013 from the Internet, <URL: http://www.fluidops.com/information-workbench/>

### SUMMARY

According to an aspect of an embodiment, a computer-readable storage medium storing a search program which causes a computer to execute a process including generating a screen that includes a display region in which a result of a predetermined search, performed on the basis of input information, with respect to a first object specified by the input information is displayed, a display region in which a result of the predetermined search with respect to both the first object and one or a plurality of objects is displayed while specifying the one or plurality of objects having a predetermined relationship with the first object that is specified by the input information, and a display region in which a result of a search on the one or plurality of objects is displayed, the one or plurality of objects having the predetermined relationship with the first object that is specified by the input information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing device according to an embodiment;

FIG. 2 is a diagram illustrating an example of a screen on which a user selects a standpoint;

FIG. 3 is a diagram illustrating an example of a page screen definition;

FIG. 4A is a diagram illustrating an example of a gadget definition;

FIG. 4B is a diagram illustrating an example of the gadget definition;

FIG. 4C is a diagram illustrating an example of the gadget definition;

FIG. 4D is a diagram illustrating an example of the gadget definition;

FIG. 5 is a diagram illustrating an example of a screen displayed by a screen display unit;

FIG. 6 is a flowchart illustrating a flow of search and display processing performed by a search unit; and

FIG. 7 is a diagram illustrating a hardware configuration of a computer which executes a search program according to an embodiment.

### DESCRIPTION OF EMBODIMENT(S)

Preferred embodiments of the present invention will be explained with reference to accompanying drawings. Note that the disclosed technology is not to be limited by the embodiments.

It is difficult to understand the relationship among the plurality of associated pieces of data by just displaying these data on the same screen. As a result, there has been a case where the information analysis of a user could not be assisted sufficiently.

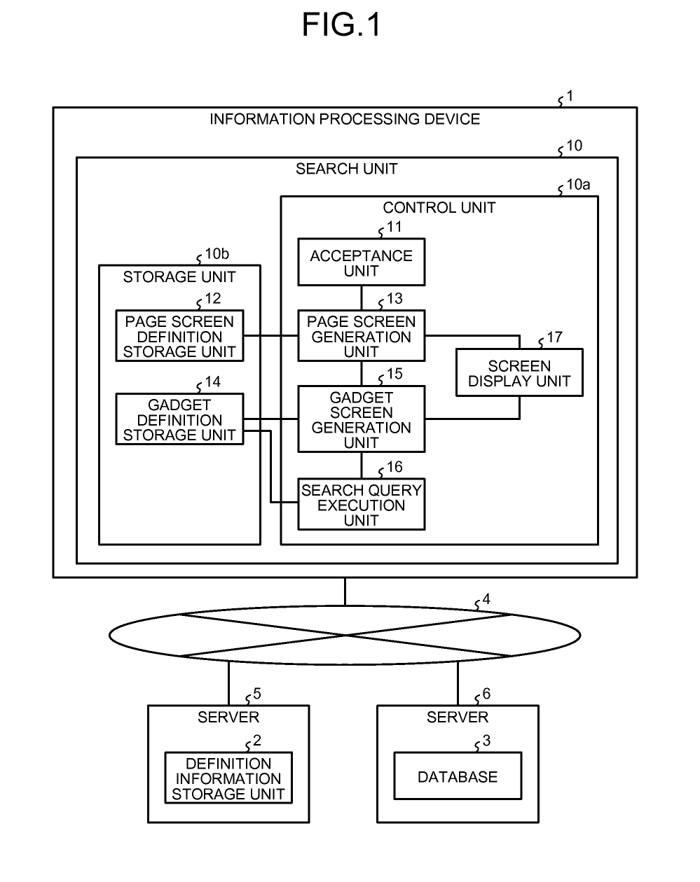

The configuration of an information processing device according to an embodiment will be described first. Here, the information processing device is a Web client used to browse a Web screen. FIG. 1 is a diagram illustrating the configuration of an information processing device 1 according to the embodiment. As illustrated in FIG. 1, the information processing device 1 includes a search unit 10 which, in displaying a Web screen on a display, searches a database 3 by using definition information stored in a definition information storage unit 2 and generates screen data.

The definition information storage unit 2 is stored in a server 5 that is connected to the information processing device 1 through a network 4, and the database 3 is stored in a server 6 that is connected to the information processing device 1 through the network 4. Note that while only one piece of the database 3 is illustrated here for the convenience of description, the search unit 10 accesses a plurality of databases through the network 4.

The search unit 10 includes a control unit 10a which performs control and a storage unit 10b which stores data or the like used for the control. The control unit 10a includes an acceptance unit 11, a page screen generation unit 13, a gadget screen generation unit 15, a search query execution unit 16, and a screen display unit 17. The storage unit 10b includes a page screen definition storage unit 12 and a gadget definition storage unit 14.

The acceptance unit 11 accepts an instruction from a user such as a focus and a standpoint. Here, the focus indicates an entity (resource) on which one focuses attention and can be a company name, a person's name, a technical term, or an event, for example. The standpoint indicates how one sees the entity, where there are a variety of standpoints for a single entity. An orderer and a vendor are the standpoints in procurement, while a manufacturer is the standpoint in product information, for example.

The focus and the standpoint are used while embedded into an URI such as http://example/standpoint/focus and http://example/focus?s=standpoint. Here, the URI is an identifier that uniquely identifies a resource in a Web space, where “standpoint” is an instance of standpoint and “focus” is an instance of focus.

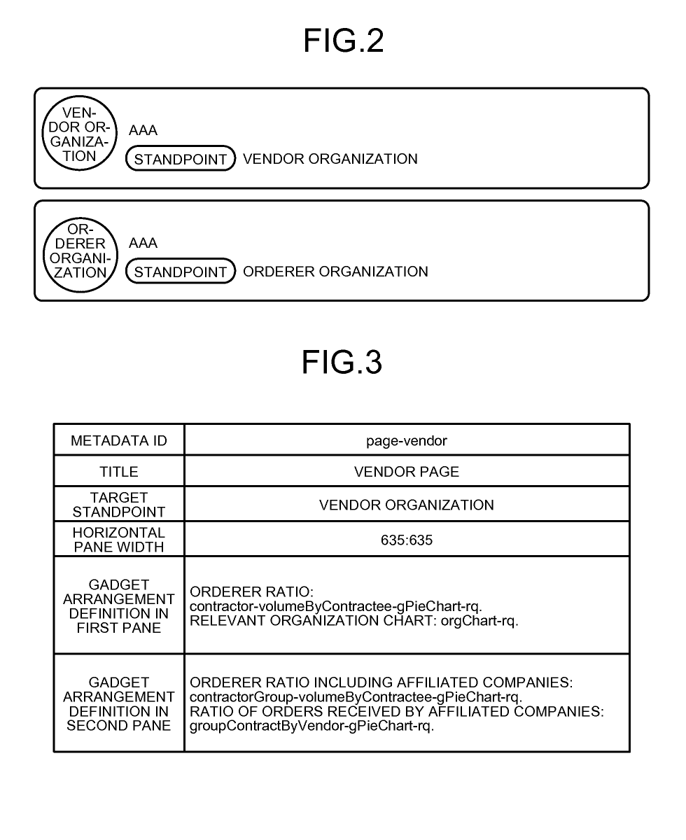

Note that the user uses a keyboard or the like to input an instance of focus and an instance of standpoint, but the acceptance unit 11 may instead cause the user to input only the focus and cause him to select the standpoint by displaying the standpoint related to the focus being input. FIG. 2 is a diagram illustrating an example of a screen on which the user selects the standpoint. FIG. 2 illustrates the example where a “vendor organization” and an “orderer organization” are displayed as selectable standpoints with respect to a company name “AAA” input as the focus by the user.

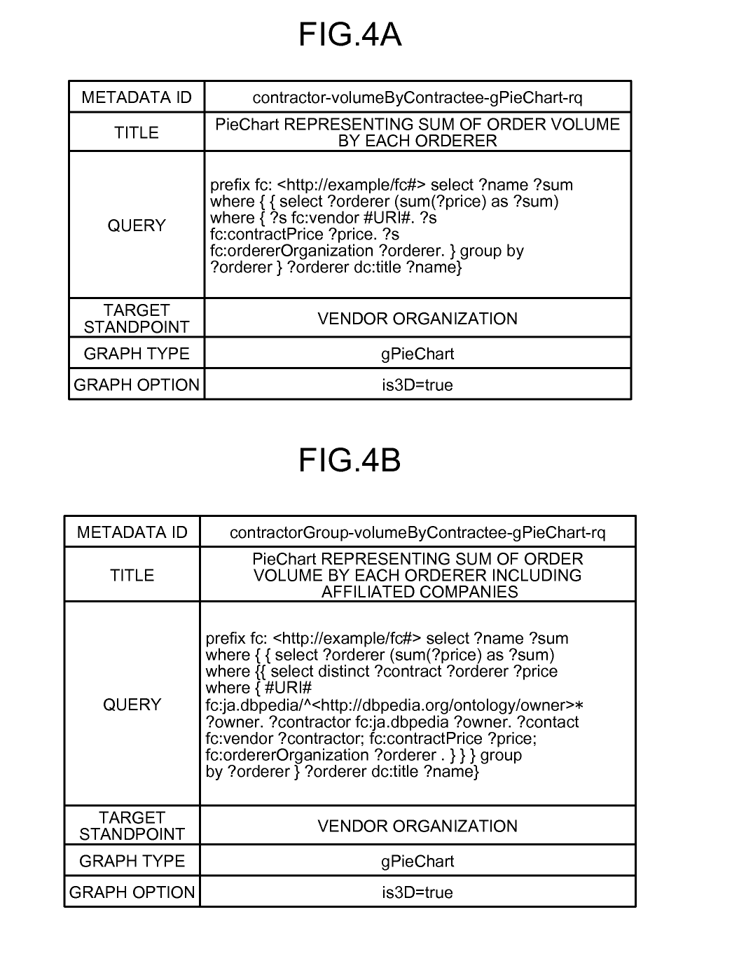

The page screen definition storage unit 12 stores a page screen definition corresponding to the standpoint. The page screen definition is a piece of information defining pane setting and gadget arrangement. Here, the “pane” is a frame dividing a computer screen. FIG. 3 is a diagram illustrating an example of the page screen definition. For the sake of simplification, a vertical division pane is assumed in this case though it is not limited thereto. As illustrated in FIG. 3, the page screen definition includes a metadata ID, a title, a target standpoint, a horizontal width of each pane (horizontal widths of two panes are specified in FIG. 3), and a gadget arrangement definition in each pane.

The metadata ID is an identifier identifying the page screen definition, and the title is a name of the page screen definition. The metadata ID is to be processed by a machine, whereas the title is provided for a person to be able to tell the page screen definition. The target standpoint is the standpoint which uses the page screen definition, and the horizontal pane width is the horizontal widths into which a screen is divided and each of which is the maximum value of the width of a gadget screen displayed in the divided screen. Here, the horizontal widths for two panes are defined as there are two panes. The page screen definition can include an arbitrary number of panes, while the number of horizontal pane widths defined corresponds with the number of panes. Moreover, the sum of the horizontal pane widths is limited by the horizontal width of a display.

The gadget arrangement definition defines the arrangement of the gadget displayed in each pane. The gadget arrangement definition includes information on a screen title displayed on a gadget screen and a gadget identifier identifying the gadget.

FIG. 3 illustrates that the page screen definition with the identifier “page-vendor” and the name “vendor page” is used for the standpoint “vendor organization” and formed of two columns of panes each having the width equal to “635”. The gadget arrangement definition in a first pane includes a gadget which has a screen title “orderer ratio” and a gadget identifier “contractor-volumeByContractee-gPieChart-rq” as well as a gadget which has a screen title “relevant organization chart” and a gadget identifier “orgChart-rq”. Gadget screens displayed by these two gadgets are displayed vertically.

The gadget arrangement definition in a second pane includes a gadget which has a screen title “orderer ratio including affiliated companies” and a gadget identifier “contractorGroup-volumeByContractee-gPieChart-rq” as well as a gadget which has a screen title “ratio of orders received by affiliated companies” and a gadget identifier “groupContractByVendor-gPieChart-rq”. Gadget screens displayed by these two gadgets are displayed vertically.

The page screen generation unit 13 searches the definition information storage unit 2 for the page screen definition corresponding to the standpoint and writes the page screen definition to the page screen definition storage unit 12. The page screen generation unit 13 then creates page screen data on the basis of the page screen definition written in the page screen definition storage unit 12.

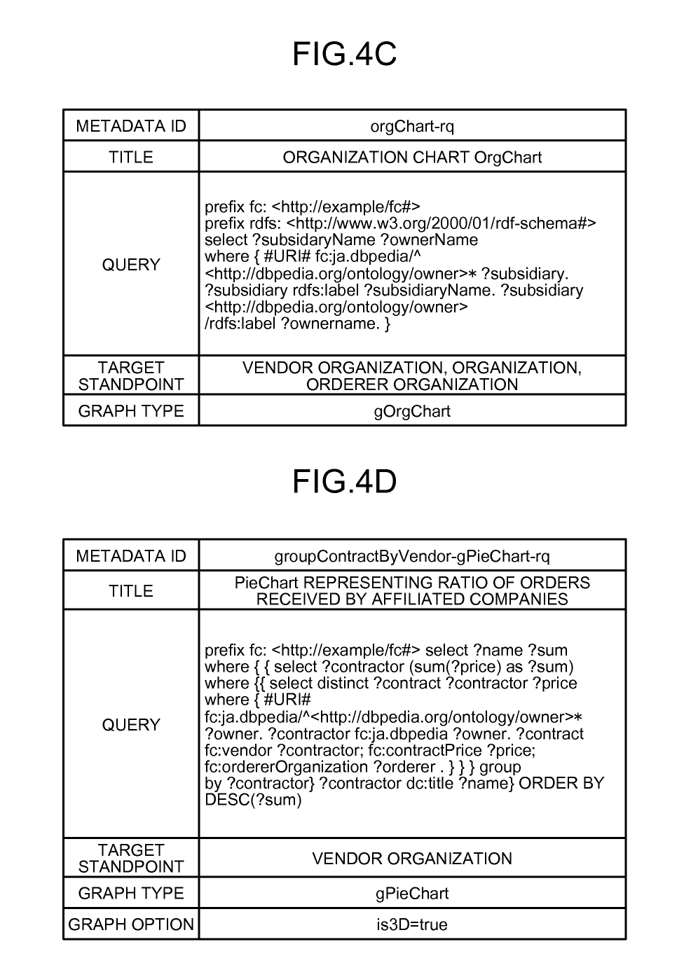

The gadget definition storage unit 14 stores a gadget definition which defines a screen to be generated. FIGS. 4A to 4D are diagrams illustrating an example of the gadget definition. As illustrated in each of FIGS. 4A to 4D, the gadget definition includes a metadata ID, a title, a query, a target standpoint, a graph type, and a graph option. Note that the graph option is omitted from FIG. 4C.

The metadata ID is an identifier identifying the gadget definition, and the title is a name of the gadget definition. The metadata ID is to be processed by a machine, whereas the title is provided for a person to be able to tell the gadget definition.

The query is a piece of information used to search for data from the database 3, and the target standpoint is the standpoint which uses the gadget definition. The graph type is a piece of information indicating a type of a graph to be displayed, and the graph option is provided to set a supplementary parameter of the graph (such as the name of an axis and a definition of an additional line) and, in this example, specifies that the graph is to be displayed in three dimensions.

FIG. 4A illustrates that a gadget definition which has an identifier “contractor-volumeByContractee-gPieChart-rq” and a name “PieChart representing sum of order volume by each orderer” is used for the standpoint “vendor organization” and has a graph of a type “gPieChart” that is displayed in three dimensions (is 3D=true).

The query specifies to search for a total amount by each orderer for orders received by the company specified as “AAA”. Here, there will be illustrated an example on the basis of an SPARQL that is typically used as an RDF query language describing Linked Data. Note that the SPARQL Query Language is explained on http://www.w3.org/TR/sparql11-query/. A part corresponding to #URI# in this description is not primarily in the specification of the SPARQL, indicating that the URI of the focus is to be replaced by what is based on the specification of the SPARQL query language. Resources are represented with URIs, which can be abbreviated as prefixed names. “prefix fc: <http://example/fc#>” declares that “a qualified name that starts fc: to stand for the longer URI, so for example the qualified name fc:foo is a shorthand for the URI http://example/fc#foo”. The query consists of two parts: the SELECT clause identifies the variables to appear in the query results, and the WHERE clause provides the basic graph pattern to match against the data graph. Note that all variable names have a question mark in the beginning. A part “SELECT ?name ?sum” we have two variables. The first one is the variable ?name to which “name of orderer” will assign, the other one is the variable ?sum to which “total amount by each orderer” will assign.

As well as choosing which variables from the pattern matching are included in the results, the SELECT clause can also introduce new variables, together with an expression that gives the value of the binding for that variable. A part “select ?orderer (sum(?price) as ?sum) where” specifies to output a pair of “?orderer (orderer)” and “?sum” matching a condition following “where” and to determine “?sum” by finding the sum of “?price” by each “?orderer” in response to a “group by” phrase described later. The triple in the query must also consists of a subject, predicate and an object but in the query, either one can be a variable. In this case, the subject is variable while the predicate and object are constant values. A predicate fc:vendor means “vender organization”, and an object #URI# means the focus, in this case “AAA”. This triple in the query is evaluated against all the RDF triples in the database, and constant values in the query triples are matched with constant values of the RDF triples in the database. So in this case, assign all of the contracts whose vendor is the organization #URI#(AAA) to variable ?s. A part “?s fc:contractPrice ?price. ?s fc:ordererOrganization ?orderer.” indicates that “fc:contractPrice (contract price)” of the contract “?s” is bound to “?price” and that “fc:ordererOrganization (orderer organization)” is bound to “?orderer”. In other words, it is specified to acquire from the database 3 each of the orderer organization and the contract price for all contracts previously bound to “?s”, and to bind the orderer organization and the contract price to “?orderer” and “?price”, respectively. As a result, the contract, the orderer organization, and the order amount with the vendor organization AAA are bound to “?s”, “?orderer”, and “?price”, respectively.

With regard to a set including the “?s”, “?orderer”, and “?price” as a group, a “group by” phrase “group by ?orderer” specifies to put together the group for each “?orderer”. At this time, “?price” is integrated as a total value by the aforementioned set function “sum”. A part “?orderer dc:title ?name” specifies to acquire the name of “?orderer” from the database 3 defined by “dc: title” and to determine the acquired name as “?name” (“?orderer” itself indicates the URI of the orderer organization, meaning that a title that is readily understandable by a person is acquired). Here, “dc:” indicates a name space “Dublin Core (http://purl.org/dc/elements/1.1/)” that is set by default.

In short, the gadget definition illustrated in FIG. 4A specifies to search for all the contracts involving “AAA” as the vendor organization, acquire the orderer organization and the contract price for each contract, integrate the price by the orderer organization, find a subtotal for the price, and display a three-dimensional pie chart for each orderer organization on the basis of the subtotal of the contract price. Where f (x) represents a function (gadget) f applied to a focus x, a function f illustrated in FIG. 4A means to “search and integrate the total amount for each orderer and display the total amount in the three-dimensional pie chart”.

FIG. 4B illustrates that a gadget definition which has an identifier “contractorGroup-volumeByContractee-gPie Chart-rq” and a name “PieChart representing sum of order volume by each orderer including affiliated companies” is used for the standpoint “vendor organization” and has a graph of a type “gPieChart” that is displayed in three dimensions.

The query specifies to search for and integrate a total amount by each orderer for orders received by the company specified as “AAA” including the affiliated companies. A part “#URI# fc:ja.dbpedia/̂<http://dbpedia.org/ontology/owner>* ?owner.” specifies to use “ja.dbpedia” (an encyclopedia in Japanese), retrieve a company, an owner or an owner of the owner of which is “AAA” that is the focus specified by #URI#, and bind the company to “?owner”. Here, “A/B” indicates a sequence path of A followed by B, “A/̂B” indicates A followed by the inverse of B, and “A*” indicates a path of zero or more occurrences of A.

A part “?contractor fc:ja.dbpedia ?owner.” specifies to bind each organization bound to “?owner” as a “?contractor” (contractor) (here, “fc:ja.dbpedia” is specified as a predicate for a bridge indicating an equivalence relation between information in a database which holds contract information and a database (the encyclopedia in Japanese) which holds company information). A part “?contract fc:vendor ?contractor; fc:contractPrice ?price; fc:ordererOrganization ?orderer.” specifies to acquire from the database 3 a set of a contract price “?price” of the contract “?contract” involving each organization “?contractor” bound above as the contractor and the orderer organization “?orderer”.

In short, the gadget definition illustrated in FIG. 4B specifies to search for and integrate the total amount by each orderer for the orders received by the company specified as “AAA” including the affiliated companies and display the amount in the three-dimensional pie chart. Where r(x) represents a function of finding an affiliated company as a relevant focus with respect to the focus x while “a” represents a function of integrating data as a way of unifying a set of a plurality of focuses (summation, count, representation, maximum value, minimum value, mean, and the like), the gadget defined in FIG. 4B is represented as f(a(r(x))).

FIG. 4C illustrates that a gadget definition which has an identifier “orgChart-rq” and a name “organization chart OrgChart” is used for the standpoints “vendor organization”, “organization”, and “orderer organization” and displays a graph of a type “gOrgChart”. Note that the graph option is omitted from FIG. 4C.

The query specifies to search for companies including the affiliated companies of the company specified as “AAA”. A part “select ?subsidiaryName ?ownerName” specifies to output pairs of “?subsidiaryName” and “?ownerName” matching a condition following “where”. This is performed as the “gOrgChart” inputs a set of a pair of the name of a parent organization and the name of a subsidiary organization under the direct control of the parent organization.

A part “#URI# . . . ?subsidiary” specifies to retrieve data of an organization that is the focus indicated by #URI# (“AAA”) from the database of the company information defined as “fc:ja.dbpedia”, and determine an organization (subsidiary organization) having the above organization as the parent organization (<http://dbpedia.org/ontology/owner>) to be “?subsidiary”. Moreover, “A/̂B*” indicates that a sequence path of A followed by the zero or more occurrences of the inverse of B, indicating there will be a subsidiary company, a subsidiary company having the aforementioned subsidiary company as the owner, and so forth. Therefore, the part “#URI# . . . ?subsidiary” specifies to retrieve all the subsidiary companies of the “AAA”. Where “g” is a function displaying members of a set in a list, the gadget defined in FIG. 4C is represented as g(r(x)).

FIG. 4D illustrates that a gadget definition which has an identifier “groupContractByVendor-gPieChart-rq” and a name “PieChart representing ratio of orders received by affiliated companies” is used for the standpoint “vendor organization” and has a graph of a type “gPieChart” that is displayed in three dimensions. The query specifies to search for an order volume of each affiliated company of the company specified as “AAA”. The gadget defined in FIG. 4D is an example of “g” different from that in FIG. 4C.

Note that while there has been described the case where the query is included in the gadget definition, the gadget definition may include the identifier identifying the query so that the definition of the query is stored separately from the gadget definition.

The gadget screen generation unit 15 searches the definition information storage unit 2 for the gadget definition identified by the gadget identifier and writes the definition into the gadget definition storage unit 14. The gadget screen generation unit 15 then creates the gadget screen data on the basis of the gadget definition written in the gadget definition storage unit 14. The gadget screen generation unit 15 further uses the search query execution unit 16 when searching for data in the database 3.

The search query execution unit 16 issues a query which searches the database 3 on the basis of the query included in the gadget definition, acquires data from a server to which the query is issued, and passes the data to the gadget screen generation unit 15.

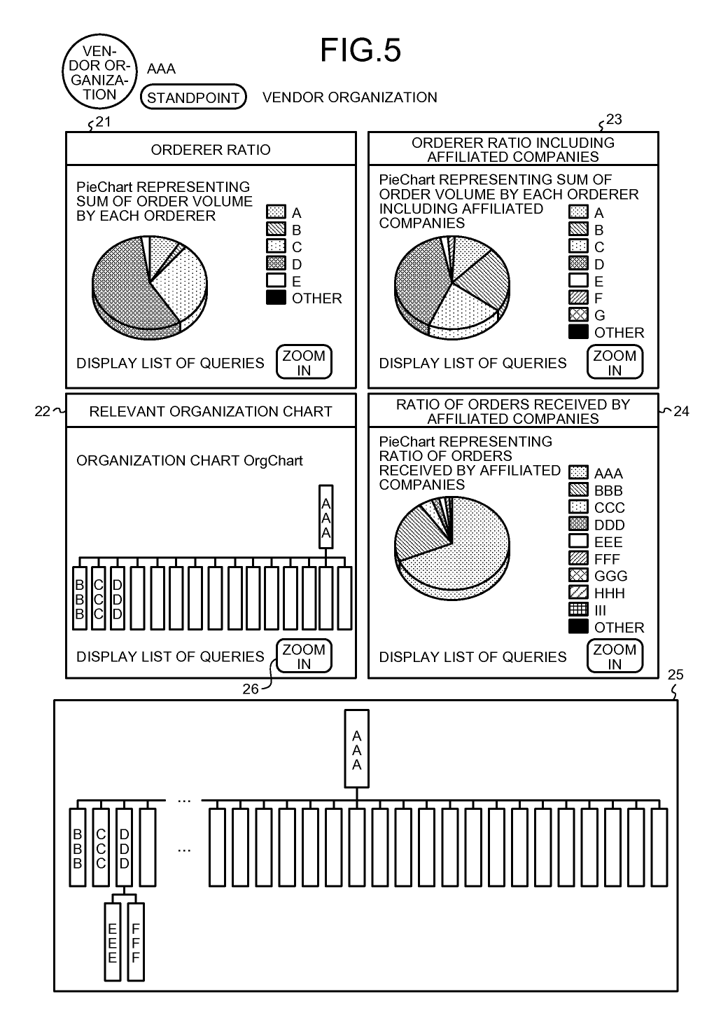

The screen display unit 17 displays a screen on the display on the basis of the screen data generated by the page screen generation unit 13 and the gadget screen generation unit 15. FIG. 5 is a diagram illustrating an example of the screen displayed by the screen display unit 17. Gadget screens 21 to 24 in FIG. 5 are screens generated by the gadget screen generation unit 15.

The gadget screens 21 and 22 are screens arranged by the gadget arrangement definition of the first pane illustrated in FIG. 3, while the gadget screens 23 and 24 are screens arranged by the gadget arrangement definition of the second pane. The gadget screen 21 is the screen displayed on the basis of the gadget definition illustrated in FIG. 4A, while the gadget screen 22 is the screen displayed on the basis of the gadget definition illustrated in FIG. 4C. The gadget screen 23 is the screen displayed on the basis of the gadget definition illustrated in FIG. 4B, while the gadget screen 24 is the screen displayed on the basis of the gadget definition illustrated in FIG. 4D.

A screen 25 is an enlarged screen displayed when the user depresses a zoom-in button 26 on the gadget screen 22, and is the enlarged screen of the gadget screen 22. Another gadget screen has a similar zoom-in button so that an enlarged screen of the gadget screen is displayed on the display when the user depresses the zoom-in button.

After the screen is displayed on the display, the screen display unit 17 performs screen display while having a dialogue with the user. Upon receiving an instruction to enlarge a screen from the user, for example, the screen display unit 17 enlarges a part of a screen and displays the screen as illustrated in FIG. 5. When the user selects a specific affiliated company on the gadget screen 22, the screen display unit 17 displays as the gadget screen 23 the sum of the order volume by each orderer pertaining to the affiliated company selected.

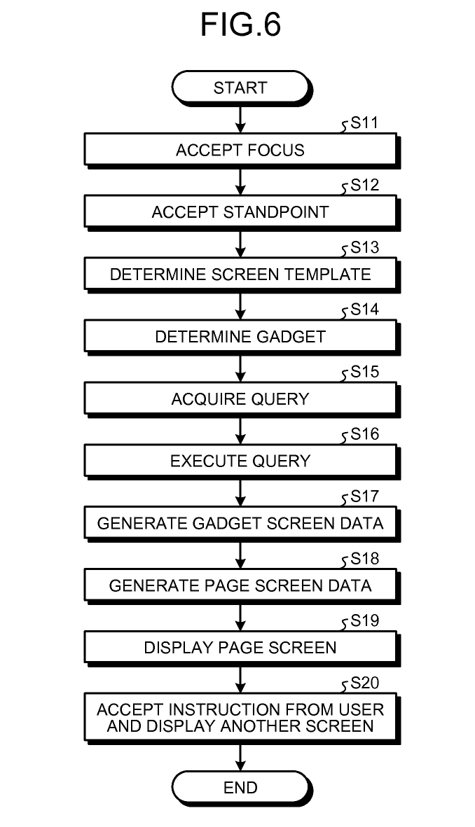

There will now be described a flow of search and display processing performed by the search unit 10. FIG. 6 is a flowchart illustrating the flow of the search and display processing performed by the search unit 10. As illustrated in FIG. 6, the acceptance unit 11 first accepts a focus specified by the user (step S11). The acceptance unit 11 accepts the company name “AAA” as the focus, for example.

The acceptance unit 11 then accepts a standpoint specified by the user (step S12). The acceptance unit 11 accepts the “vendor organization” as the standpoint, for example. The page screen generation unit 13 thereafter determines a screen template on the basis of the standpoint (step S13) and acquires information on the screen template from the definition information storage unit 2. Here, the screen template is a template defined by the page screen definition. The page screen generation unit 13 acquires the page screen definition illustrated in FIG. 3, for example.

Next, the page screen generation unit 13 determines a gadget on the basis of the information on the screen template (step S14), and the gadget screen generation unit 15 acquires a query, namely a query, from the gadget definition (step S15). The search query execution unit 16 executes the query (step S16), so that the gadget screen generation unit 15 generates gadget screen data (step S17). Note that the process performed in each of steps S15 to S17 is repeated the number of times corresponding to the number of gadgets. The gadget screen generation unit 15 generates the screen data for four gadgets on the basis of the gadget definition illustrated in FIGS. 4A to 4D, for example.

Next, the page screen generation unit 13 generates page screen data (step S18), and then the screen display unit 17 displays a page screen including the gadget screen on the display (step S19). The screen display unit 17 displays the screen illustrated in FIG. 5, for example. The screen display unit 17 then receives an instruction from the user to display another screen (step S20). The screen display unit 17 displays an enlarged screen or a pie chart representing the sum of the order volume by each orderer pertaining to the affiliated company selected by the user, for example.

As a result of the processing, the search unit 10 can display side by side the pie chart representing the sum of the order volume by each orderer, the pie chart representing the sum of the order volume by each orderer including the affiliated company, and the organization chart of the affiliated company on the screen with regard to the company specified as the focus, for example.

In the embodiment, as described above, the acceptance unit 11 accepts the focus and the standpoint from the user so that the page screen generation unit 13 acquires the page screen definition on the basis of the standpoint. The gadget screen generation unit 15 then uses the plurality of gadget definitions included in the page screen definition to generate the plurality of pieces of screen data. The screen display unit 17 thereafter displays the screen including the plurality of gadget screens. Accordingly, the search unit 10 can perform the search with respect to both the searched object specified as the focus and objects relevant to the searched object as well as with respect to the searched object in the same manner by using the gadget defined to perform the search with respect to both the searched object and the objects relevant to the searched object as well as with respect to the searched object in the same manner, thereby allowing the search result of the searched object and the searched result of both the searched object and the objects relevant to the searched object to be displayed side by side.

That is, where f(x) is the function (gadget) f applied to the focus x and r(x) is the function of finding relevant focuses with respect to the focus x, the search unit 10 simultaneously presents f(x) and f(r(x)) in which the function f is applied to the application result of “r”. This allows the user to easily compare f(x) and f(r(x)).

When r(x) gives a set of a plurality of focuses, the search unit 10 makes “f” applicable by using a function “a” which unifies the plurality of focuses as an intermediary and then presents f(x) and f(a(r(x))) simultaneously. This allows the user to easily compare f(x) and f(a(r(x))).

The search unit 10 further presents r(x) as g(r(x)) through a gadget g. This allows the user to easily compare f(x) and f(a(r(x))) while referring to g(r(x)).

For example, “x” corresponds to an entity such as a company, a person, an event, and a technology (concept). The function “f” collects, calculates, and visualizes data according to a certain standpoint and, for example, acquires a total amount of procurement information and represents it in a pie chart by each orderer for a company, or collects papers written by a researcher and represents the number of papers by the fiscal year in a line graph. The function “r” finds group companies or competitors of a certain company. Alternatively, the function “r” finds a spouse of a person or finds all researchers in an organization to which a certain researcher belongs.

The function “a” is called a set function and finds the sum, the maximum value, the minimum value, the mean, or the total number of data each of which is relevant to an individual result found by r(x). The function “g” presents a member of the set in an appropriate format such as a list or a pie chart to which a certain attribute of each member is added.

When a company is the focus and a vendor organization is the standpoint, for example, the search unit 10 displays the sum of the order volume by each orderer in the pie chart as an outcome of f(x). When the function “r” finds group companies including affiliated companies and the function “a” finds the sum of data, the search unit 10 displays the sum of the order volume by each orderer including the affiliated companies in the pie chart as an outcome of f(a(r(x))). When the function “g” performs list display, the search unit 10 displays the organization chart as an outcome of g(r(x)). The user can thus easily grasp the difference in orderers between the case with the company only and the case including the company and the affiliated companies.

When the user selects a specific affiliated company, the search unit 10 displays the sum of the order volume by each orderer pertaining to the selected affiliated company in the pie chart. The user can thus easily grasp the difference in orderers between the selected affiliated company and the group companies.

Note that while the search unit 10 has been described in the embodiment, a search program having a similar function can be obtained by realizing a configuration included in the search unit 10 by software. Now, there will be described a computer executing the search program.

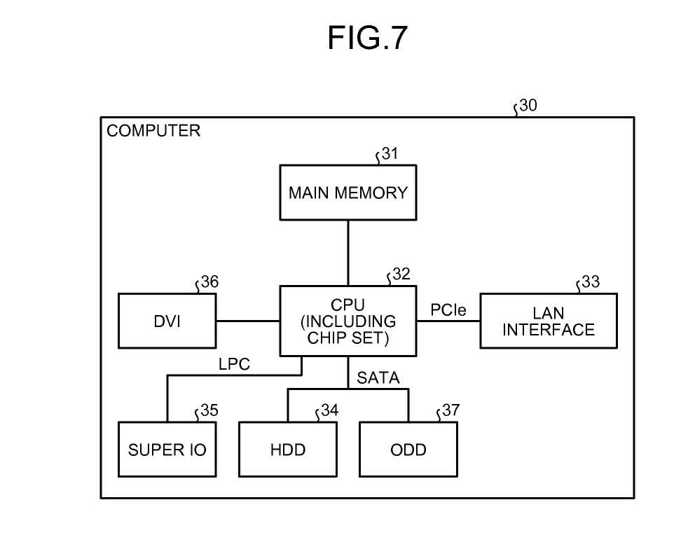

FIG. 7 is a diagram illustrating a hardware configuration of the computer which executes the search program according to an embodiment. As illustrated in FIG. 7, a computer 30 includes a main memory 31, a CPU (Central Processing Unit) 32, a LAN (Local Area Network) interface 33, and an HDD (Hard Disk Drive) 34. The computer 30 further includes a super IO (Input Output) 35, a DVI (Digital Visual Interface) 36, and an ODD (Optical Disk Drive) 37.

The main memory 31 is a memory storing a program and an intermediate result of a program being executed. The CPU 32 is a central processing unit which reads the program from the main memory 31 and executes the program. The CPU 32 includes a chip set having a memory controller.

The LAN interface 33 is an interface which connects the computer 30 to other computers via a LAN. The HDD 34 is a disk unit which stores a program and data, and the super IO 35 is an interface which connects input devices such as a mouse and a keyboard. The DVI 36 is an interface which connects a liquid crystal display, and the ODD 37 is a unit which performs read/write from/to a DVD.

The LAN interface 33 is connected to the CPU 32 by a PCI express (PCIe), while the HDD 34 and the ODD 37 are connected to the CPU 32 by an SATA (Serial Advanced Technology Attachment). The super IO 35 is connected to the CPU 32 by an LPC (Low Pin Count).

The search program executed in the computer 30 is stored in a DVD, read from the DVD by the ODD 37, and installed to the computer 30. Alternatively, the search program is stored in a database of another computer system connected through the LAN interface 33, read from the database, and installed to the computer 30. The installed search program is stored in the HDD 34, read by the main memory 31, and executed by the CPU 32.

In searching a database with respect to a searched object and displaying, according to one embodiment, one may perform a similar search with respect to both the searched object and objects associated with the searched object as well to be able to display search results side by side.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable storage medium that stores a search program which causes a computer to execute a process comprising:
generating a screen image that includes a display region in which a first result of a predetermined search performed with respect to a first object specified by the input information is displayed, a display region in which a second result of the predetermined search performed with respect to both the first object and one or a plurality of objects is displayed, the one or plurality of objects having a predetermined relationship with the first object, and a display region in which a third result of a search performed with respect to the one or plurality of objects is displayed.

2. The computer-readable storage medium according to claim 1, wherein the computer executes the process further comprising:
displaying a fourth result of the predetermined search with respect to an object that is selected from among the one or plurality of objects in the display region in which the third result of the search with respect to the one or plurality of objects is displayed.

3. The computer-readable storage medium according to claim 1, wherein the display region in which the first result of the predetermined search performed with respect to the first object is displayed displays a processing result based on the first result of the predetermined search, and the display region in which the second result of the predetermined search performed with respect to both the first object and the one or plurality of objects is displayed displays a processing result based on the second result of the predetermined search performed with respect to the both.

4. A computer-readable storage medium that stores a search program which causes a computer to execute a process comprising:
executing search processing allocated in advance to each of a plurality of gadgets, on the basis of input information, by each of the plurality of gadgets corresponding to an attribute of an object that is specified by the input information; and
displaying an execution result of the each search processing in each display region allocated to each gadget.

5. A non-transitory computer-readable storage medium that stores a search program which causes a computer to execute a process comprising:
presenting a plurality of selection items related to a search performed according to input information;
executing each search processing allocated in advance to each gadget included in a combination of gadgets corresponding to an item selected from among the plurality of selection items; and
outputting an execution result of the each search processing in each display region allocated to the corresponding gadget.

6. The computer-readable storage medium according to claim 5, wherein a searched object of the predetermined search is a database of Linked Data.

7. The computer-readable storage medium according to claim 5, wherein the combination of gadgets includes a first gadget to which a predetermined search with respect to a first object specified by the input information is allocated, a second gadget to which the predetermined search with respect to both the first object and one or a plurality of objects is allocated while specifying the one or plurality of objects having a predetermined relationship with the first object that is specified by the input information, and a third gadget to which a search on the one or plurality of objects is allocated, the one or plurality of objects having the predetermined relationship with the first object that is specified by the input information.

8. A search method comprising:
generating a screen image that includes a display region in which a first result of a predetermined search performed with respect to a first object specified by the input information is displayed, a display region in which a second result of the predetermined search performed with respect to both the first object and one or a plurality of objects is displayed, the one or plurality of objects having a predetermined relationship with the first object, and a display region in which a third result of a search performed with respect to the one or plurality of objects is displayed.

9. An information processing device comprising:
a processor that executes a process comprising:
generating a screen image that includes a display region in which a first result of a predetermined search performed with respect to a first object specified by the input information is displayed, a display region in which a second result of the predetermined search performed with respect to both the first object and one or a plurality of objects is displayed, the one or plurality of objects having a predetermined relationship with the first object, and a display region in which a third result of a search performed with respect to the one or plurality of objects is displayed.
